(19) United States
(12) Patent Application Publication
(10) Pub. No.: US 2016/0170170 A1
(43) Pub. Date: Jun. 16, 2016

(54) CAMERA MODULE

(71) Applicant: SAMSUNG ELECTRO-MECHANICS CO., LTD., Suwon-si (KR)

(72) Inventors: Byung Chul GO, Suwon-si (KR); Chul Jin KIM, Suwon-si (KR); Soo Cheol LIM, Suwon-si (KR)

(73) Assignee: SAMSUNG ELECTRO-MECHANICS CO., LTD., Suwon-si (KR)

(21) Appl. No.: 14/965,070

(22) Filed: Dec. 10, 2015

(30) Foreign Application Priority Data
Dec. 15, 2014 (KR) 10-2014-0180727

(51) Int. Cl. G02B 7/09; H04N 5/225; G02B 27/64

(52) U.S. Cl. CPC G02B 7/09; G02B 27/646; H04N 5/2252; H04N 5/2253

(57) ABSTRACT

A camera module having a housing accommodating a lens module; a lens driver, comprising a magnet mounted in the housing, configured to induce a driving force along an optical axis direction and in a direction perpendicular to the optical axis direction; and a yoke portion offset from the magnet along the optical axis direction.

### CROSS-REFERENCE TO RELATED APPLICATION(S)

This application claims the benefit under 35 USC 119(a) of Korean Patent Application No. 10-2014-0180727 filed on Dec. 15, 2014, in the Korean Intellectual Property Office, the entire disclosure of which is incorporated herein by reference for all purposes.

### BACKGROUND

1. Field

The present disclosure relates to a camera module.

2. Description of Related Art

Highly functional, ultra-small camera modules have recently been provided in mobile communications terminals such as tablet PCs, laptop computers, and the like, as well as cellular phones such as smartphones.

Camera modules have advanced from fixed focus camera modules to auto-focusing camera modules having auto-focus (AF) actuators. As mobile communication terminals continue to be miniaturized, incidence of image distortions, caused by a hand-shake during image capturing, increases. Optical image stabilization (OIS) actuators have been used to stabilize camera modules in the case of hand-shake. When a magnet is used in the AF actuator and the OIS actuator, a magnetic field formed by the magnet may be influenced by external magnetism generated around the camera module.

Therefore, since the magnetic field of the magnet may be influenced by external magnetism during driving for auto-focusing or OIS, a problem in which the camera module malfunctions or is not driven in an exact location may occur.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module is capable of reducing an influence of external magnetism and improving driving reliability in auto-focusing and optical image stabilization (OIS). The camera module includes a lens driver including a magnet generating a driving force in an optical axis direction and in a direction perpendicular to the optical axis direction; and a yoke portion spaced apart from the magnet in the optical axis direction. A magnetic field of the magnet is formed in a relatively small space, thereby reducing an influence of external magnetism.

In another general aspect, a camera module having a housing accommodating a lens module; a lens driver, comprising a magnet mounted in the housing, configured to induce a driving force along an optical axis direction and in a direction perpendicular to the optical axis direction; and a yoke portion offset from the magnet along the optical axis direction.

A method of reducing external magnetic interference in a lens module comprising: disposing lens module within a housing; disposing a first coil within the lens module; disposing a second coil on an inner surface of a case; disposing a magnet between the first coil and the second coil, wherein the magnet generates a magnetic field; and disposing a yoke offset from the magnet along an optical axis, wherein the yoke comprises a magnetic material that limits the size of the magnetic field of the magnet.

### BRIEF DESCRIPTION OF DRAWINGS

FIG. 1 is a perspective view of a camera module;

FIG. 2 is an exploded perspective view of a camera module;

FIG. 3 is an exploded perspective view of a camera module;

FIG. 4 is a schematic perspective view of the arrangement of a lens driver and a yoke portion; and

FIG. 5 is a cross-sectional view of line A-A′ of FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

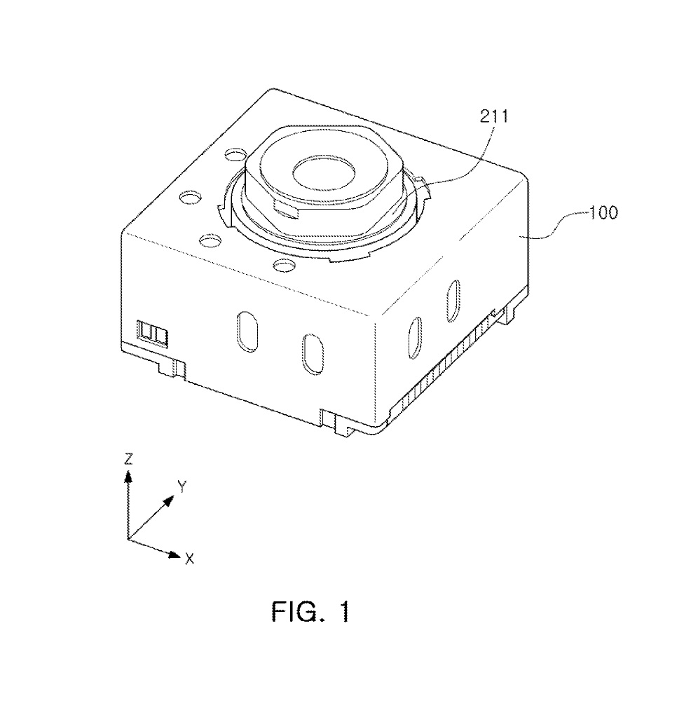

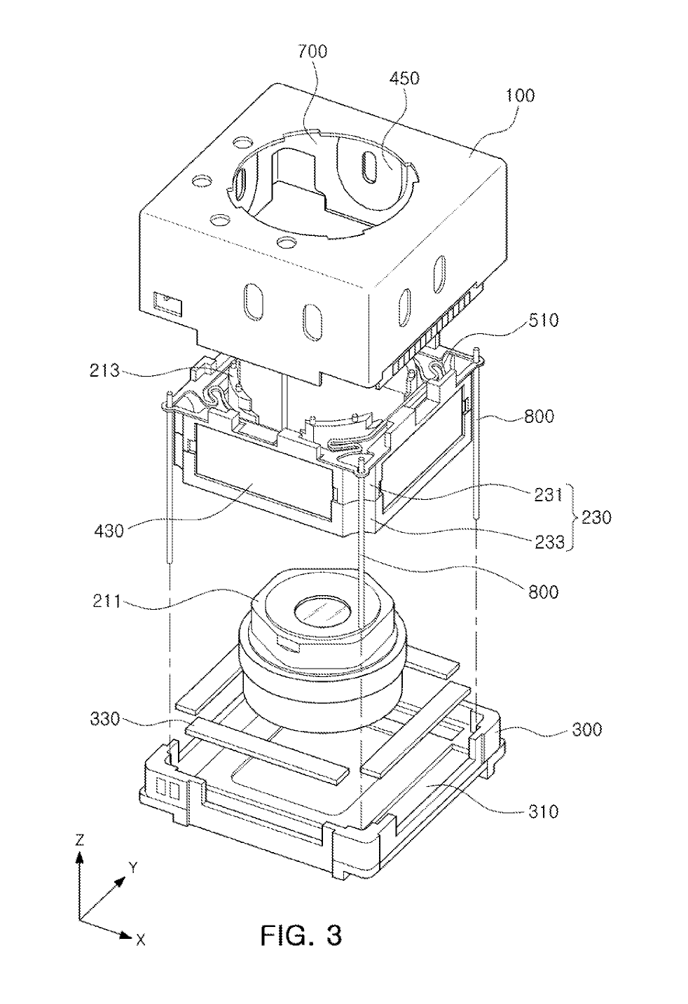

Words describing relative spatial relationships, such as “below”, “beneath”, “under”, “lower”, “bottom”, “above”, “over”, “upper”, “top”, “left”, and “right”, may be used to conveniently describe spatial relationships of one device or elements with other devices or elements. Such words are to be interpreted as encompassing a device oriented as illustrated in the drawings, and in other orientations in use or operation. For example, an example in which a device includes a second element disposed above a first element based on the orientation of the device illustrated in the drawings also encompasses the device when the device is flipped upside down in use or operation, Regarding directions, an optical axis direction (Z axis direction) seen in FIGS. 1-5 means upward and downward directions in relation to a lens barrel 211.

Referring to FIGS. 1 through 3, a camera module includes a lens module 210, a housing 230 accommodating the lens module 210, a lens driver 400 driving the lens module 210 and the housing 230, a frame 300 spaced apart from the housing 230 in an optical axis direction (Z direction), and a case 100 coupled to the frame 300. The lens module 210 includes a lens barrel 211 and a bobbin 213 in which the lens barrel 211 is mounted. The lens barrel 211 has a hollow cylindrical shape such that a plurality of lenses imaging a subject may be accommodated therein. The plurality of lenses are provided in the lens barrel 211 on an optical axis.

The number of lenses stacked in the lens barrel 211 may vary according to a design of the lens module 210. The plurality of lenses have optical characteristics such as the same or different refractive indices, or any combination thereof.

The lens barrel 211 is coupled to the bobbin 213. For example, the lens barrel 211 is fixed by being inserted into a hollow portion of the bobbin 213. The bobbin 213 is accommodated in the housing 230 along with the lens barrel 211 and is driven along the optical axis direction (Z direction) for auto-focusing the camera module 210. The housing 230 may be driven in directions (X direction and Y direction) perpendicular to the optical axis direction (Z direction) for optical image stabilization (OIS) while accommodating the lens module 210 therein. In this regard, the lens module 210 and the housing 230 function as a driver 200 driven for auto-focusing and OIS.

The frame 300 is spaced apart from the driver 200 in the optical axis direction (Z direction). A window is formed in the frame 300 such that light may be transmitted therethrough.

A first substrate 600 in which an image sensor 610 is mounted is coupled to a lower portion of the frame 300. The case 100 is coupled to the frame 300 to enclose the housing 230 and may function to block electromagnetic waves generated while the camera module is driven. That is, when the camera module is driven, electromagnetic waves are generated, and when electromagnetic waves are emitted externally, electromagnetic waves influence other electronic components, causing communication problems or malfunctions. The case 100 is formed of a metal material so that the case 100 may be grounded to a ground pad included in the first substrate 600, and thus electromagnetic waves are blocked. When the case 100 is provided as a plastic molding, an inner surface of the case 100 is coated with conductive paint, and thus, electromagnetic waves are blocked. Conductive epoxy may be used as the conductive paint, but the conductive paint is not limited thereto and various conductive materials may be used. A conductive film or a conductive tape may be attached to the inner surface of the case 100.

A lens driver 400 is provided in the camera module to drive the lens module 210 in the optical axis direction (Z direction) or drive the housing 230 in the X direction and Y direction perpendicular to the optical axis direction (Z direction). The lens driver 400 includes a first coil 410, a magnet 430, and a second coil 450. The first coil 410 is provided on an outer surface of the bobbin 213, and the magnet 430 is mounted in the housing 230, facing the first coil 410 for auto-focusing. The housing 230 is provided to have open sides such that the magnet 430 and the first coil 410 face each other.

For example, the housing 230 includes a first housing 231 and a second housing 233 coupled to each other in the optical axis direction (Z direction). Each of the first housing 231 and the second housing 233 includes a rectangular support plate having a hollow, cylindrical member extending in the optical axis direction (Z direction) and formed in each corner of the support plate. Therefore, the magnet 430 is mounted in open sides of the housing 230 so that the magnet 430 faces the first coil 410 in the directions (X direction and Y direction) perpendicular to the optical axis direction (Z direction).

The magnet 430 forms a uniform magnetic field. If power is supplied to the first coil 410, driving force is generated by an electromagnetic field between the magnet 430 and the first coil 410. The lens module 210 may be moved by the driving force in the housing 230 in the optical axis direction (Z direction). The lens module 210 is moved by the operation described above and thus auto-focusing or a zooming function may be performed.

The housing 230 includes one or more elastic, or flexible members 510 and 530 elastically supporting the bobbin 213. For example, the first elastic member 510 is disposed in the first housing 231 to elastically support the bobbin 213, and the second elastic member 530 is disposed below the second housing 233 to elastically support the bobbin 213.

Optical image stabilization (OIS) is used to stabilize blurring of an image or shaking of a moving image due to a factor such as user hand-shake when the image and the moving image are captured. For example, when hand-shake occurs, a relative displacement is provided to the housing 230 in the directions (X direction and Y direction) perpendicular to the optical axis direction (Z direction), and thus hand-shake is nullified.

The second coil 450 is disposed to face the magnet 430. For example, the second coil 450 is mounted in a second substrate 700 attached to the inner surface of the case 100, such that the second coil 450 faces the magnet 430 in the directions (X direction and Y direction) perpendicular to the optical axis direction (Z direction).

A Hall sensor (not shown) is mounted in the second substrate 700 in a location adjacent to the second coil 450 to sense a location of the magnet 430. The magnet 430 forms a uniform magnetic field. When power is supplied to the second coil 450, a driving force is generated by the electromagnetic influence between the magnet 430 and the second coil 450. The housing 230 is moved by the driving force in the directions (X direction and Y direction) perpendicular to the optical axis direction (Z direction).

The lens module 210 is disposed in the housing 230, and thus the lens module 210 may be driven through the driving of the housing 230 in the directions (X direction and Y direction) perpendicular to the optical axis direction (Z direction). The housing 230 is moved by the operation described above, and thus an OIS function may be performed.

A suspension wire 800 for supporting the driving of the housing 230 in the directions (X direction and Y direction) perpendicular to the optical axis direction (Z direction) is provided. The suspension wire 800 has one end fixed to the first substrate 600, and the other end fixed to the first elastic member 510 of the housing 230. Thus, the suspension wire 800 regulates a space between the housing 230 and the frame 300 along the optical axis direction (Z direction).

Four suspension wires 800, disposed in respective corners of the frame 300, support driving of the housing 230 when hand-shake is stabilized.

The suspension wire 800 also supplies power to the first coil 410. One end of the suspension wire 800 is fixed to the first substrate 600, the other end thereof is fixed to the first elastic member 510, and the first elastic member 510 is connected to a lead wire of the first coil 410, and thus the first coil 410 may be supplied with power through the suspension wire 800.

A yoke portion 330 is mounted in an accommodation groove 310 in the frame 300. The yoke portion 330 is mounted in the accommodation groove 310 so that the yoke portion 330 is spaced apart from the magnet 430 in the optical axis direction (Z direction).

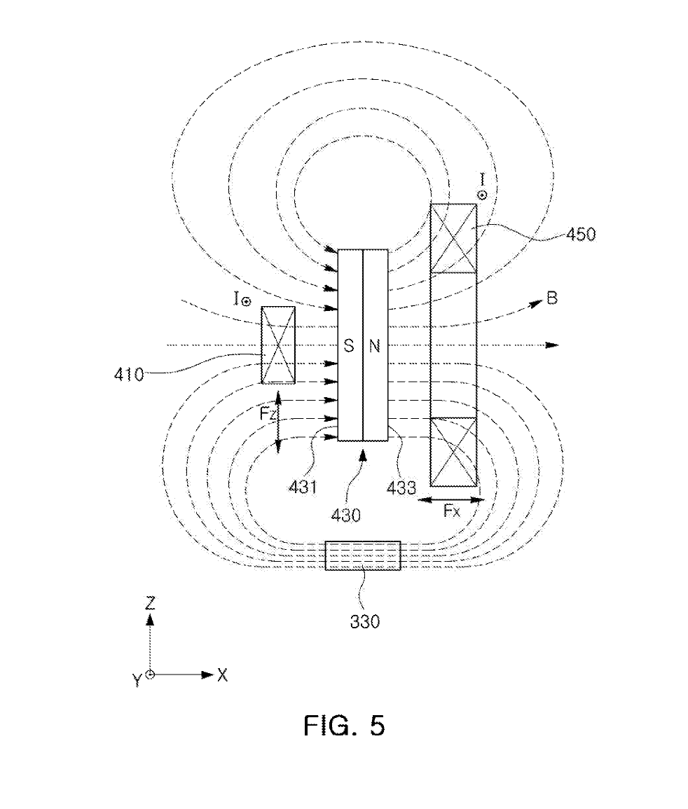

As shown in FIG. 5, the yoke portion 330 is disposed on a path of a closed circuit formed by a magnetic force line of the magnet 430. In this regard, a space in which the magnetic field is present around the magnet 430 is relatively reduced by the yoke portion 330. For example, the path of the closed circuit of the magnetic force line starting at an N pole of the magnet 430 and returning to an S pole may be reduced by the yoke portion 330.

Without the yoke portion 330, the magnetic field of the magnet 430 is formed in a relatively large space. However, when the yoke portion 330 is provided, the magnetic field of the magnet 430 passes through the yoke portion 330, and thus the magnetic field of the magnet 430 acts in a relatively small space. In other words, the magnetic force line starts at the N pole of the magnet 430 and returns to the S pole through the yoke portion 330, and thus the path of the closed circuit formed by the magnetic force line is reduced.

When the camera module according to an exemplary embodiment in the present disclosure is mounted in a portable electronic device such as a smartphone, the magnetic field of the magnet 430 provided in the camera module may be influenced by another magnetic material mounted in the portable electronic device. Therefore, during a driving process for OIS, the magnetic field of the magnet 430 is affected by an external magnetism, and thus the housing 230 may malfunction or may not be driven at an exact location.

The camera module provides the yoke portion 330 to face the magnet 430 in the optical axis direction (Z direction) to allow the magnetic field of the magnet 430 to be formed in a relatively small space, thereby reducing an influence of external magnetism when driving for OIS. The yoke 430 provides a magnetic pulling power between the magnet 430 and the yoke portion 330 in the optical axis direction (Z direction). For example, the yoke portion 330 mounted in the frame 300 comprises a magnetic or metallic substance, and thus the magnetic interactions may occur between the magnet 430 and the yoke portion 330. The yoke portion 330 is fixed to the frame 300 through the coupling groove 310, and thus the magnet 430 may be pulled in a direction toward the yoke portion 330 by the magnetic pulling power.

Accordingly, the housing 230 in which the magnet 430 is mounted may be pulled in a direction toward the frame 300 in which the yoke portion 330 is mounted. Thus, even in the case that an external shock, such as a hand shake, is generated, the space between the frame 300 and the housing 230 is maintained, and thus the camera module reliability is increased.

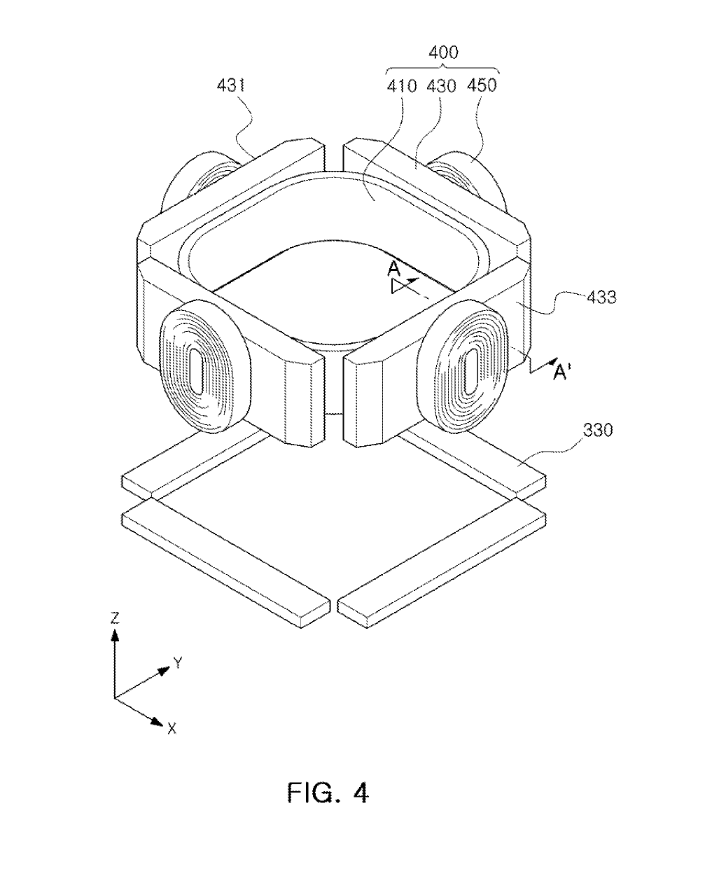

The arrangement of the lens driver 400 and the yoke portion will be described with reference to FIGS. 4 and 5.

As described above, the lens driver 400 includes the first coil 410, the magnet 430, and the second coil 450. The first coil 410 is wound on an outer surface of the bobbin 213 in one direction. The magnet 430 is mounted in the housing 230 to face the first coil 410 in the directions (X direction and Y direction) perpendicular to the optical axis direction (Z direction).

The second coil 450 is provided in a toroidal shape having a hollow center and is mounted in the second substrate 700 provided in an inner surface of the case 100 such that the second coil 450 faces the magnet 430 in the directions (X direction and Y direction) perpendicular to the optical axis direction (Z direction).

Thus, as shown in FIG. 4, the magnet 430 is disposed between the first coil 410 and the second coil 450 and includes a first surface 431 facing the first coil 410 and a second surface 433 facing the second coil 450.

The magnet 430 is used in both driving for auto-focusing and driving for OIS. For example, a magnet for auto-focusing and a magnet for OIS are not separately provided to the lens driver 400, but the magnet 430 is used in both auto-focusing and OIS, thereby reducing the size of a small camera module. That is, the lens driver 400 may implement both auto-focusing and OIS functions, and thus the number of components for implementing auto-focusing and OIS functions may be reduced, thereby making the camera module smaller.

Referring to FIG. 5, the first surface 431 and the second surface 433 of the magnet 430 have different poles. For example, the first surface 431 of the magnet 430 has an S pole, and the second surface 433 of the magnet 430 has an N pole. First, a direction of an electromagnetic force Fz by an interaction between the first coil 410 and the magnet 430 during auto-focusing driving will be described.

A magnetic field B of the magnet 430 interacts with the first coil 410 in the X direction. In this regard, if power is supplied to the first coil 410, current I flows in the Y direction, a direction (X direction) of the magnetic field B of the magnet 430 and a direction (Y direction) in which the current I flows in the first coil 410 are orthogonal to each other, and thus the electromagnetic force Fz acts in the Z direction through interaction between the first coil 410 and the magnet 430. Therefore, the lens module 210 may be driven in the optical axis direction (Z direction) by the first coil 410 and the magnet 430.

Next, a direction of an electromagnetic force Fx by an interaction between the second coil 450 and the magnet 430 during OIS driving will be described. The magnetic field B of the magnet 430 interacts with the second coil 450 in the Z direction. In this regard, if power is supplied to the second coil 450, the current I flows in the Y direction, a direction (Z direction) of the magnetic field B of the magnet 430 and a direction (Y direction) in which the current I flows in the second coil 450 are orthogonal to each other, and thus the electromagnetic force Fx by the interaction between the second coil 450 and the magnet 430 acts in the X direction. Therefore, the housing 230 may be driven in the directions (X direction and Y direction) perpendicular to the optical axis direction (Z direction) by the second coil 450 and the magnet 430.

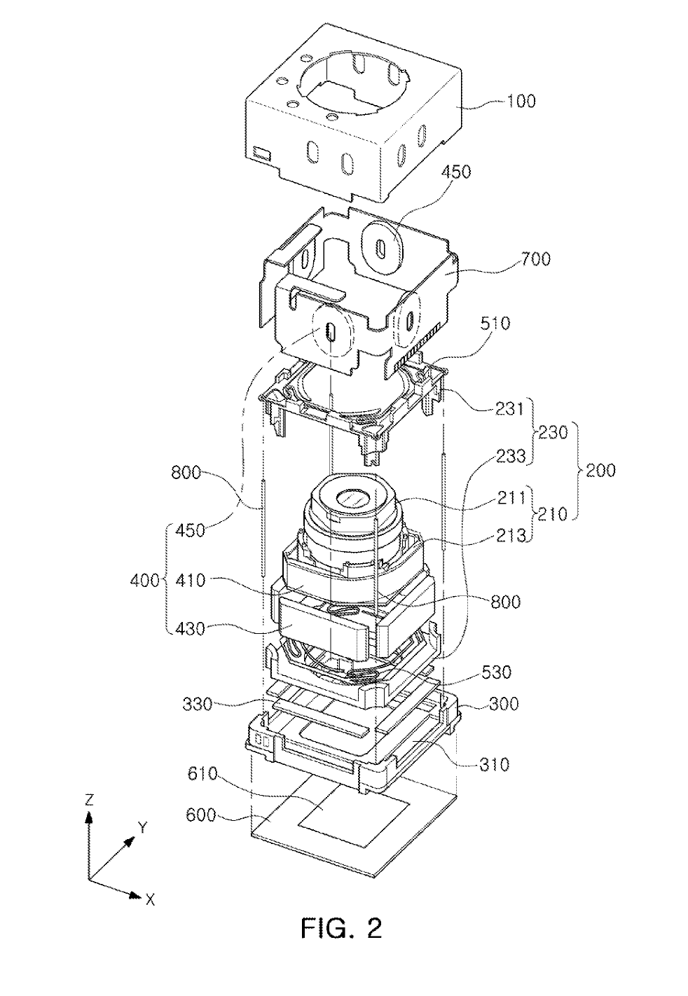

Although the electromagnetic force Fx is described as acting in the X direction during OIS driving, for convenience of description, the electromagnetic force Fy acts similarly in the Y direction through an interaction between the magnet 430 another a coil 450 on another portion of the second substrate 700, as shown in FIGS. 2 and 4.

As shown in FIGS. 2-4, the yoke portion 330 is disposed to be spaced apart from the magnet 430 along the optical axis direction (Z direction). A magnetic force line, or magnetic flux, of the magnet 430 passes through the yoke portion 330, and thus a closed circuit path formed by the magnetic force line of the magnet 430 is reduced. In other words, the distance in which the magnetic field extends, is reduced.

Without the yoke portion 330 (an upper side of the Z direction in FIG. 5), the magnetic field of the magnet 430 acts in a relatively large space, whereas when the yoke portion 330 is provided (a lower side of the Z direction in FIG. 5), the magnetic field of the magnet 430 passes through the yoke portion 330, and thus the magnetic field of the magnet 430 acts in a relatively small space. Therefore, an influence of external magnetism may be reduced during driving for OIS.

A magnetic flux of the magnet 430 is focused on the first coil 410 and the second coil 450 by the yoke portion 330, thereby smoothly driving auto-focusing and OIS. Although the yoke portion 330 is disposed in the lower side of the magnet 430 in the Z direction in FIG. 5, the yoke portion 330 may be disposed on the upper and lower sides of the magnet 430 in the Z direction. As set forth above, the camera module reduces an influence on external magnetism and improve driving reliability for auto-focusing and OIS.

As a non-exhaustive example only, a mobile communication terminal as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing accommodating a lens module;
a lens driver, comprising a magnet mounted in the housing, configured to induce a driving force along an optical axis and a direction perpendicular to the optical axis direction; and
a yoke portion offset from the magnet along the optical axis direction.

2. The camera module of claim 1, further comprising a frame, wherein the yoke portion is mounted in the frame.

3. The camera module of claim 2, further comprising:
a first substrate coupled to the frame, wherein an image sensor is mounted on the first substrate; and
a suspension wire, wherein one end of the suspension wire is fixed to the first substrate and the other end fixed to the housing.

4. The camera module of claim 3, wherein the housing includes at least one flexible member supporting the lens module.

5. The camera module of claim 4, wherein another end of the suspension wire is fixed to the elastic member.

6. The camera module of claim 1, wherein the magnet generates a magnetic field passing through the yoke portion.

7. The camera module of claim 1, wherein the lens driver further comprises a first coil and a second coil disposed on two sides of the magnet and facing the magnet in the direction perpendicular to the optical axis direction.

8. The camera module of claim 7, wherein a first surface of the magnet facing the first coil and a second surface of the magnet facing the second coil have different poles.

9. The camera module of claim 2, wherein the frame comprises an accommodation groove, and the yoke portion is disposed in the accommodation groove.

10. The camera module of claim 1, wherein the yoke portion is made from a magnetic material.

11. The camera module of claim 9, wherein a path of a closed circuit of a magnetic force line of the magnet passes through the yoke portion.

12. A camera module comprising:
a housing accommodating a lens module;
a case enclosing the housing;
a lens driver including a first coil provided in the lens module, a magnet mounted in the housing, facing the first coil, and a second coil mounted in an inner surface of the case facing the magnet; and
a yoke portion disposed on a path of a closed circuit of a magnetic force line of the magnet.

13. The camera module of claim 11, wherein the yoke portion is offset from the magnet along an optical axis direction.

14. The camera module of claim 11, wherein a first surface of the magnet facing the first coil and a second surface of the magnet facing the second coil have different poles.

15. A method of reducing external magnetic interference in a lens module comprising:
disposing lens module within a housing;
disposing a first coil within the lens module;
disposing a second coil on an inner surface of a case;
disposing a magnet between the first coil and the second coil, wherein the magnet generates a magnetic field; and
disposing a yoke offset from the magnet along an optical axis, wherein the yoke comprises a magnetic material that limits the size of the magnetic field of the magnet.
